(19) United States
(12) Patent Application Publication
(10) Pub. No.: US 2025/0350421 A1
(43) Pub. Date: Nov. 13, 2025

(54) Methods And Apparatus For Layer 1 Transmission Or Reception Configuration For Quasi-Colocation In Mobile Communications

(71) Applicant: MediaTek Inc., Hsinchu City (TW)

(72) Inventors: Cheng-Rung Tsai, Hsinchu City (TW); Din-Hwa Huang, Hsinchu City (TW); Chia-Hao Yu, Hsinchu City (TW); Yi-Ru Chen, Hsinchu City (TW)

(21) Appl. No.: 19/192,400

(22) Filed: Apr. 29, 2025

Related U.S. Application Data
(60) Provisional application No. 63/645,221, filed on May 10, 2024.

(51) Int. Cl. H04L 5/00; H04B 7/06

(52) U.S. Cl. CPC H04L 5/0048; H04B 7/06968; H04L 5/0044

(57) ABSTRACT

Various solutions for layer 1 (L1) transmission or reception (Tx/Rx) configuration for quasi-colocation (QCL) with respect to user equipment (UE) and network apparatus in mobile communications are described. The UE may receive at least one L1 Tx/Rx configuration associated with at least one source reference signal and at least one parameter. Further, the UE may receive a second configuration indicating whether the at least one L1 Tx/Rx configuration is applicable to a target reference signal or target channel. Therefore, the UE may transmit or receive the target reference signal or target channel based on the at least one parameter in an event that the second configuration indicates that the at least one L1 Tx/Rx configuration is applicable to the target reference signal or target channel.

### CROSS REFERENCE TO RELATED PATENT APPLICATION(S)

The present disclosure is part of a non-provisional application claiming the priority benefit of U.S. patent application Ser. No. 63/645,221, filed 10 May 2024, the content of which herein being incorporated by reference in its entirety.

### TECHNICAL FIELD

The present disclosure is generally related to mobile communications and, more particularly, to layer 1 (L1) transmission or reception (Tx/Rx) configuration for quasi-colocation (QCL) with respect to user equipment (UE) and network apparatus in mobile communications.

### BACKGROUND

Unless otherwise indicated herein, approaches described in this section are not prior art to the claims listed below and are not admitted as prior art by inclusion in this section.

Quasi-colocation (QCL) in 5G New Radio (NR) refers to a scenario where a UE can assume that different antenna ports have certain large-scale channel properties in common. These properties include Doppler spread. Doppler shift, average delay, and delay spread. The QCL framework allows the UE to reuse channel estimation results obtained from a source reference signal for the reception of another signal or channel that is declared as QCL with the first. This reduces the UE's receiver complexity and power consumption.

However, the current developed QCL framework employs a complex QCL relationship between the source and target reference signals, which results in complicated QCL updates and indications, especially when using the transmission configuration indicator (TCI) framework to configure the QCL relationship. Therefore, a novel scheme for QCL configuration is needed to mitigate these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to layer 1 (L1) transmission or reception (Tx/Rx) configuration for quasi-colocation (QCL) with respect to user equipment (UE) and network apparatus in mobile communications.

In one aspect, a method may involve an apparatus receiving at least one L1 Tx/Rx configuration associated with at least one source reference signal and at least one parameter. The method may also involve the apparatus receiving a second configuration indicating whether the at least one L1 Tx/Rx configuration is applicable to a target reference signal/target channel. The method may further involve the apparatus transmitting or receiving the target reference signal/target channel based on the at least one parameter in an event that the second configuration indicates that the at least one L1 Tx/Rx configuration is applicable to the target reference signal/target channel.

In another aspect, an apparatus may comprise a transceiver which, during operation, wirelessly communicates with a network. The apparatus may also comprise a processor communicatively coupled to the transceiver. The processor, during operation, may perform operations comprising receiving at least one L1 Tx/Rx configuration via the transceiver. Specifically, the at least one L1 Tx/Rx configuration is associated with at least one source reference signal and at least one parameter. The processor, during operation, may also perform operations comprising receiving, via the transceiver, a second configuration indicating whether the at least one L1 Tx/Rx configuration is applicable to a target reference signal/target channel. The processor, during operation, may further perform operations comprising transmitting or receiving, via the transceiver, the target reference signal/target channel based on the at least one parameter in an event that the second configuration indicates that the at least one L1 Tx/Rx configuration is applicable to the target reference signal/target channel.

In yet another aspect, a method may involve a network node transmitting at least one L1 Tx/Rx configuration associated with at least one source reference signal and at least one parameter. The method may also involve the network node transmitting a second configuration indicating whether the at least one L1 Tx/Rx configuration is applicable to a target reference signal/target channel.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting a hierarchical quasi-colocation (QCL) structure in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to layer 1 (L1) transmission or reception (Tx/Rx) configuration for quasi-colocation (QCL) with respect to user equipment (UE) and network apparatus in mobile communications. According to the present disclosure, a number of possible solutions may be implemented separately or jointly. That is, although these possible solutions may be described below separately, two or more of these possible solutions may be implemented in one combination or another.

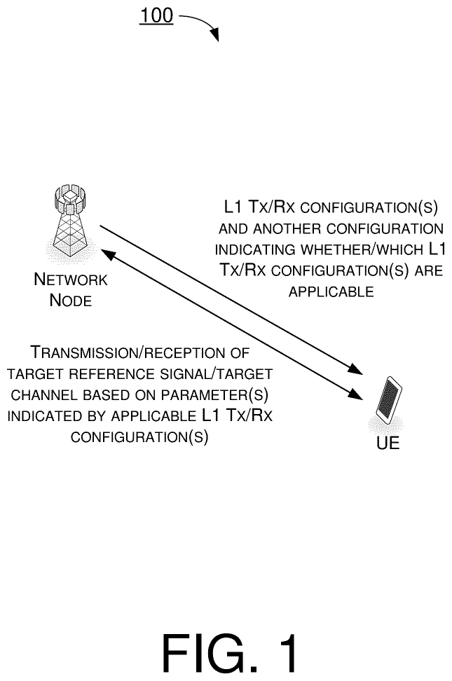

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network, or a 6G network). Scenario 100 illustrates the network framework. The UE may connect to the network side. The network side may comprise one or more network nodes.

In some embodiments, scenario 100 supports a hierarchical quasi-colocation (QCL) structure, in which a source reference signal and a target reference signal or target channel (target reference signal/target channel) having a QCL relationship reside in two immediately adjacent layers of the QCL structure. However, the QCL structure supported by scenario 100 is not limited thereto. In some embodiments, the network node may transmit one, two, four, or more L1 Tx/Rx configurations to the UE, with each L1 Tx/Rx configuration associated with at least one source reference signal and at least one parameter. These L1 Tx/Rx configuration(s) are specifically provided to facilitate UE-dedicated downlink (DL) and uplink (UL) receptions and transmissions. When the UE is served by a single transmission reception point (TRP), the network node may transmit only one L1 Tx/Rx configuration to the UE. Multiple L1 Tx/Rx configurations may be utilized for multi-TRP operation/mobility. The L1 Tx/Rx configuration may be transmitted through RRC signaling, MAC-CE, DCI, or a combination thereof. For example, the network node may use RRC signaling to configure the initial parameter(s) of each L1 Tx/Rx configuration. Subsequently, the network node may utilize MAC-CE and/or DCI to dynamically update the parameters within each L1 Tx/Rx configuration.

Furthermore, the network node may utilize RRC signaling and/or DCI to transmit another configuration indicating whether an L1 Tx/Rx configuration is applicable to a target reference signal/target channel, essentially configuring whether or not to follow an L1 Tx/Rx configuration and, if multiple exist, which L1 Tx/Rx configuration(s) to follow. In one example, the network node may utilize RRC signaling to configure the baseline association between the L1 Tx/Rx configuration(s) and a target reference signal/target channel. For DL/UL receptions/transmissions scheduled by DCI, the scheduling DCI may indicate the specific L1 Tx/Rx configuration(s) to be employed for the scheduled DL/UL receptions/transmissions, particularly in multi-TRP scenarios. Accordingly, the UE may transmit or receive the target reference signal/target channel based on the parameter(s) provided by the applicable L1 Tx/Rx configuration(s).

In some embodiment, the parameter(s) provided by the L1 Tx/Rx configuration may include a DL related parameter, a UL related parameter, or both. The DL related parameter may include QCL assumption(s) for DL reception. The UL related parameter may include one or a combination of a spatial relation for UL transmission, a Tx power control (PC) parameter, and a timing advance (TA) parameter. In some embodiments, the spatial relation for UL transmission may share the same source reference signal for QCL assumption(s). The Tx PC parameter may include a pathloss reference signal, a P0 index associated with target received power, an alpha value (e.g., a pathloss compensation factor), a closed-loop index, or a combination thereof. In some embodiments, an individual pathloss reference signal may be provided, if the pathloss reference signal does not share the same source reference signal for QCL assumption(s) or spatial relation. It is to be understood that the scope of parameters provided by the L1 Tx/Rx configuration is not limited to the aforementioned.

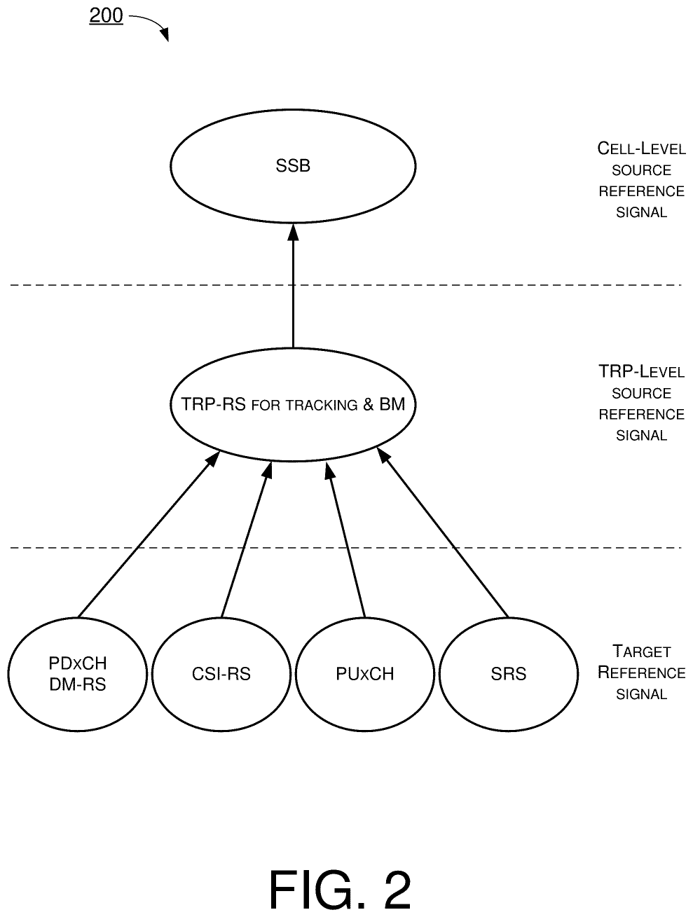

FIG. 2 is a diagram depicting a hierarchical QCL structure 200 in accordance with implementations of the present disclosure. As shown in FIG. 2, the hierarchical QCL structure 200 includes three layers, and each arrow in the hierarchical QCL structure 200 points from a target reference signal/target channel to a source reference signal. Specifically, a synchronization signal block (SSB) serves as the cell-level source reference signal and is the source reference signal for a transmission reception point reference signal (TRP-RS). In one embodiment, the TRP-RS is, for example, for time/frequency tracking and beam management (BM). That is, time/frequency tracking and BM share the same reference signal resource. The TRP-RS, as the TRP-level source reference signal, is the source reference signal for the target reference signals/target channels such as a physical downlink shared channel (PDSCH) demodulation reference signal (DM-RS), a physical downlink control channel (PDCCH) DM-RS, a channel state information reference signal (CSI-RS), a physical uplink shared channel (PUSCH), a physical uplink control channel (PUCCH), and a sounding reference signal (SRS). In the present disclosure, the target reference signal/target channel may include the signal or channel shown in FIG. 2, as well as other signals or channels.

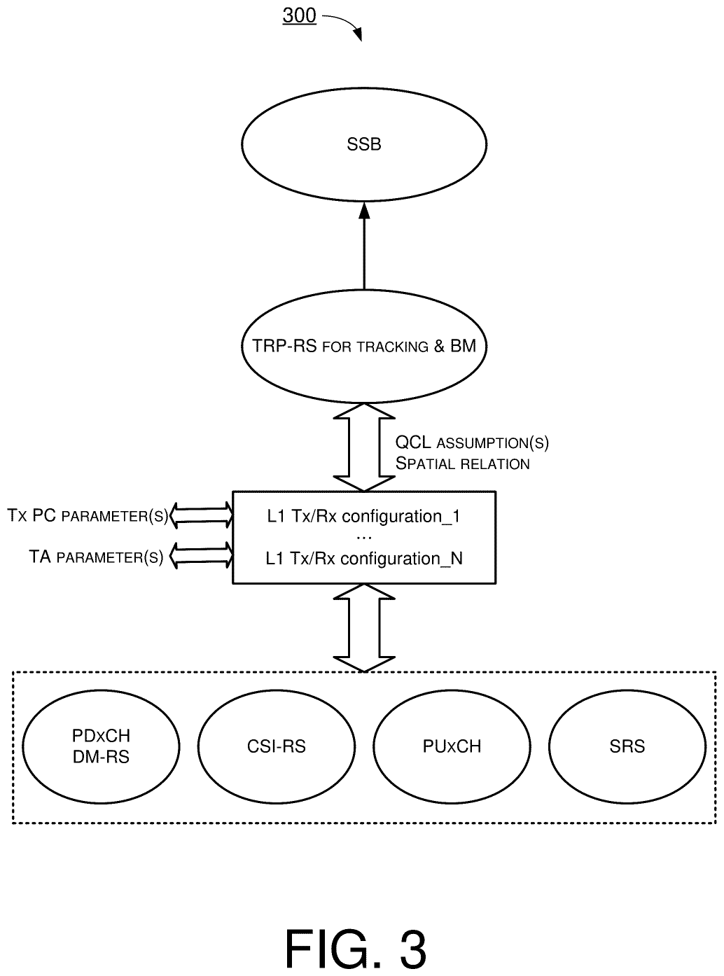

The PDSCH/PDCCH DM-RS (i.e., PDxCH DM-RS) and the CSI-RS are associated with DL reception while the PUSCH/PUCCH (i.e., PUxCH) and the SRS are associated with UL transmission. In some embodiments, when a joint DL/UL mode is supported, the target reference signal(s)/target channel(s) associated with DL reception and the target reference signal(s)/target channel(s) associated with UL transmission share the same L1 Tx/Rx configuration(s). FIG. 3 illustrates a scenario 300 when the joint DL/UL mode is supported. In scenario 300, each of the L1 Tx/Rx configuration_1 through L1 Tx/Rx configuration_N (where N is an integer) received by the UE is shared by the PDxCH DM-RS and the CSI-RS associated with DL reception and the PUxCH and the SRS associated with UL transmission. For example, each of the L1 Tx/Rx configuration_1 through L1 Tx/Rx configuration_N may provide the QCL assumption(s) for DL reception, spatial relation for UL transmission, Tx PC parameter(s), and TA parameter(s). Specifically, the QCL assumption(s) for DL reception and spatial relation for UL transmission share the same source reference signal (i.e., TRP-RS). However, the Tx PC parameter(s) and TA parameter(s) do not share the same source reference signa for QCL assumption(s) or spatial relation. The UE may utilize the parameters within the applicable L1 Tx/Rx configuration to receive the PDxCH DM-RS and the CSI-RS and to transmit the PUxCH and the SRS.

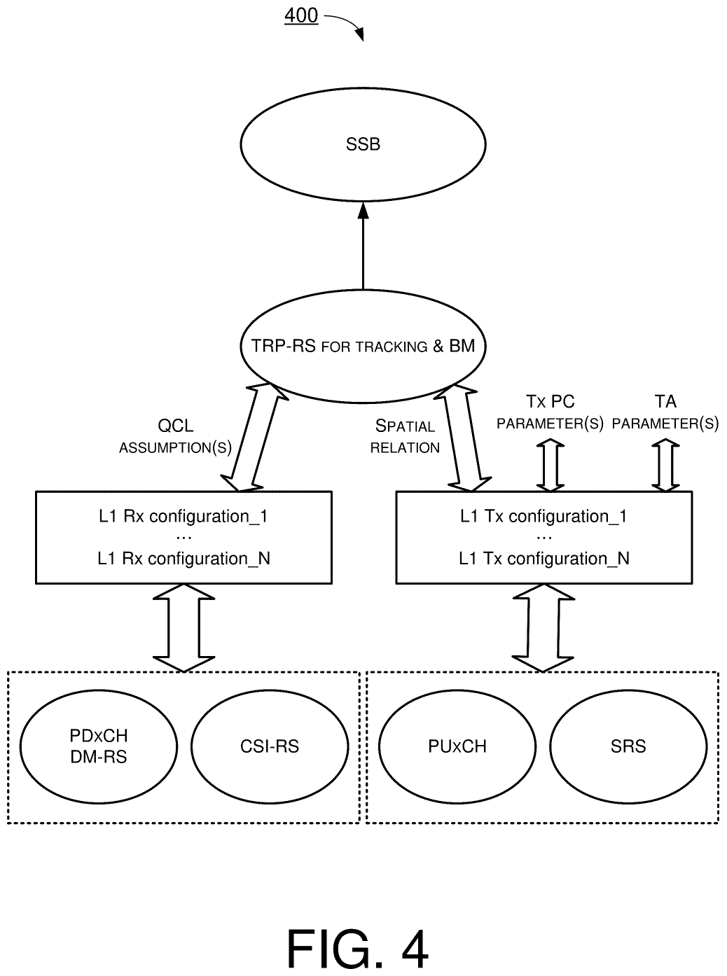

FIG. 4 illustrates a scenario 400 when a separate DL/UL mode is supported. In scenario 400, each of the L1 Rx configuration_1 through L1 Rx configuration_N (where N is an integer) received by the UE provide the QCL assumption(s) for receiving the PDxCH DM-RS and the CSI-RS. Each of the L1 Tx configuration_1 through L1 Tx configuration_N (where N is an integer) received by the UE provide the spatial relation, Tx PC parameter(s), and TA parameter(s) for transmitting the PUxCH and the SRS. That is, separate L1 Rx configuration(s) and L1 Tx configuration(s) are used for DL receptions and UL transmissions, respectively.

In one embodiment, the network node transmits a single L1 Tx/Rx configuration to the UE. And the UE is configured to follow the parameters provided by the L1 Tx/Rx configuration to receive the PDXCH DM-RS and the CSI-RS, and to transmit the PUxCH and the SRS. In another embodiment, the network node transmits two L1 Tx/Rx configurations to the UE, one is the primary Tx/Rx configuration and the other is the secondary Tx/Rx configuration. The UE may use the parameters provided by the primary Tx/Rx configuration to receive the PDxCH DM-RS and the CSI-RS, and to transmit the PUxCH and the SRS, by default. The UE may use the parameters provided by the secondary Tx/Rx configuration to receive the PDxCH DM-RS and the CSI-RS, and to transmit the PUxCH and the SRS only if a configuration indicating that the secondary Tx/Rx configuration is applicable is received. Specifically, the primary L1 Tx/Rx configuration may be used for common DL/UL channel(s), such as the PDCCH on the common search space and its corresponding PDSCH/PUSCH, as well as non-dedicated PUCCH resources. Furthermore, the primary L1 Tx/Rx configuration may be used for UE-dedicated DL/UL channel(s)/signal(s), including PDCCH with UE-specific search space and respective PDSCH/PUSCH, and dedicated PUCCH resources, under specific conditions. These conditions may include scenarios following initial higher layer configuration or higher reconfiguration involving a synchronization procedure, situations where a secondary L1 Tx/Rx configuration is not provided, or instances where no RRC or DCI signaling explicitly indicates that a UE-dedicated DL/UL channel should adhere to the secondary L1 Tx/Rx configuration. Conversely, the secondary L1 Tx/Rx configuration, if provided, may be used for any DL/UL channel, but its application is contingent upon RRC or DCI signaling explicitly indicating that the particular DL/UL channel should follow this secondary L1 Tx/Rx configuration. That is, the secondary L1 Tx/Rx configuration can be used for any DL/UL channel, but the application of this configuration to particular DL/UL channel depends on the network explicitly informing the UE via RRC or DCI signaling.

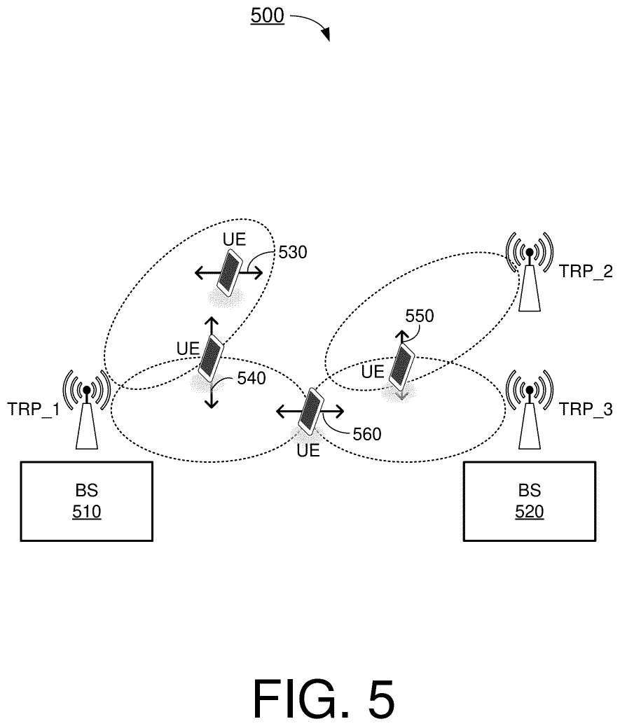

FIG. 5 is a diagram depicting an example scenario 500 of different mobility cases. In scenario 500, base station (BS) 510 is associated with TRP_1 while BS 520 is associated with TRP_2 and TRP_3. For instance, a primary L1 Tx/Rx configuration, or both a primary and a secondary L1 Tx/Rx configuration may be provided to handle various mobility cases. In the first case, no update to the primary L1 Tx/Rx configuration associated with TRP_1 is required, as the UE movement 530 occurs within the same BS (i.e., BS 510) and under the same beam. The second case involves updating the primary L1 Tx/Rx configuration associated with TRP_1, which typically occurs when the UE movement 540 is within the same BS but switches beams, necessitating changes in QCL assumptions or pathloss reference signals. The third case utilizes both the primary and secondary L1 Tx/Rx configurations. As indicated by the UE movement 550, this scenario encompasses multi-connectivity for CONNECTED mode mobility, where the UE may be connected to two TRPs within the same BS (i.e., BS 520), and multi-TRP schemes, where the UE remains within the coverage area of two TRPs. In one example, the primary L1 Tx/Rx configuration is associated with TRP_2, and the secondary L1 Tx/Rx configuration is associated with TRP_3. Receiving L1 Tx/Rx configurations from both TRP_2 and TRP_3 simultaneously provides enhanced throughput and reliability. In the fourth case, the UE movement 560 involves an RRC-based layer 3 (L3) mobility, with a handover to a different BS configured via RRC signaling, and therefore, L1 parameter updates are not necessary.

### Illustrative Implementations

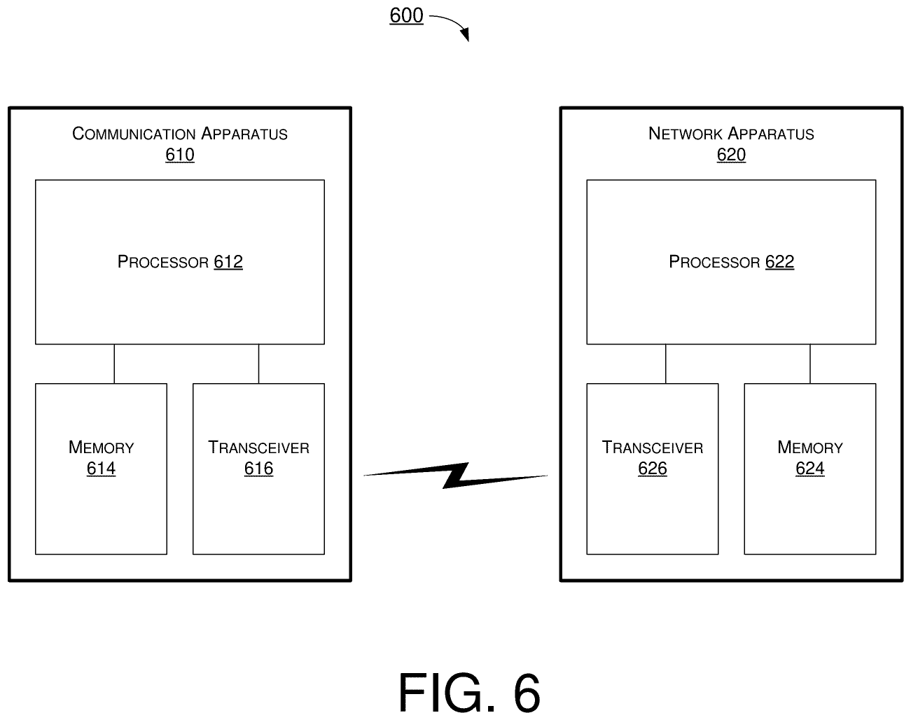

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to L1 Tx/Rx configuration for QCL with respect to UE and network apparatus in mobile communications, including scenarios/schemes described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including L1 Tx/Rx configuration for QCL in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively.

To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

### Illustrative Processes

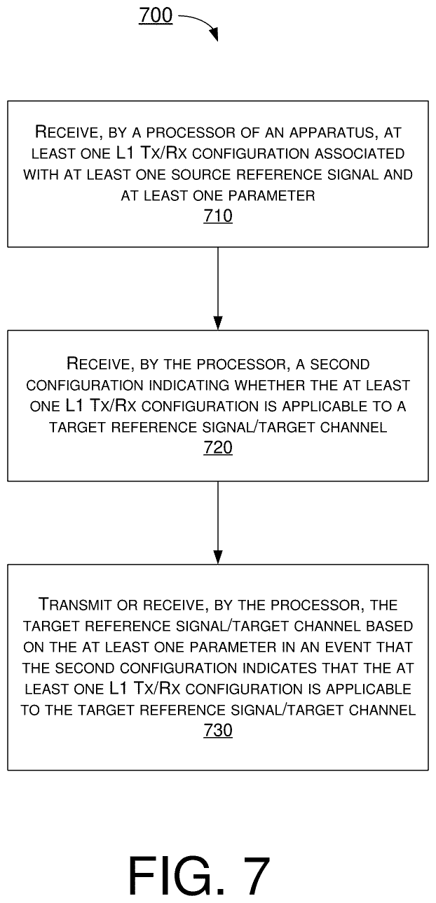

FIG. 7 illustrates an example process 700 in accordance with an implementation of the present disclosure. Process 700 may be an example implementation of above scenarios/schemes, whether partially or completely, with respect to L1 Tx/Rx configuration for QCL of the present disclosure. Process 700 may represent an aspect of implementation of features of communication apparatus 610. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of communication apparatus 610 receiving, via transceiver 616, at least one L1 Tx/Rx configuration associated with at least one source reference signal and at least one parameter. Process 700 may proceed from block 710 to block 720.

At block 720, process 700 may involve processor 612 of communication apparatus 610 receiving, via transceiver 616, a second configuration indicating whether the at least one L1 Tx/Rx configuration is applicable to a target reference signal/target channel. Process 700 may proceed from block 720 to block 730.

At block 730, process 700 may involve processor 612 of communication apparatus 610 transmitting or receiving, via transceiver 616, the target reference signal/target channel based on the at least one parameter in an event that the second configuration indicates that the at least one L1 Tx/Rx configuration is applicable to the target reference signal/target channel.

In some implementations, the at least one source reference signal may include a TRP-RS. The target reference signal/target channel may include at least one of a PDSCH DM-RS, a PDCCH DM-RS, a CSI-RS, a PUSCH, a PUCCH, and an SRS.

In some implementations, the at least one L1 Tx/Rx configuration is received through at least one of an RRC signaling, a MAC-CE, and a DCI.

In some implementations, the parameter(s) may include at least one of a DL related parameter and a UL related parameter.

In some implementations, the DL related parameter may include a QCL assumption for DL reception.

In some implementations, the UL related parameter may include at least one of a spatial relation for UL transmission, a Tx PC parameter, and a TA parameter.

In some implementations, the second configuration indicating whether the at least one L1 Tx/Rx configuration is applicable to the target reference signal/target channel is received through at least one of an RRC signaling and a DCI.

In some implementations, a first target reference signal/target channel associated with a DL reception and a second target reference signal/target channel associated with a UL transmission are indicated to share at least one L1 Tx/Rx configuration.

In some implementations, a first target reference signal/target channel associated with a DL reception and a second target reference signal/target channel associated with a UL transmission are indicated to follow respective L1 Tx/Rx configurations.

In some implementations, the at least one L1 Tx/Rx configuration may include a primary L1 Tx/Rx configuration and a secondary L1 Tx/Rx configuration. Process 700 may also involve processor 612 of communication apparatus 610 transmitting or receiving, via transceiver 616, the target reference signal/target channel based on the primary L1 Tx/Rx configuration by default. Process 700 may further involve processor 612 of communication apparatus 610 transmitting or receiving, via transceiver 616, the target reference signal/target channel based on the secondary L1 Tx/Rx configuration in an event that a third configuration indicating the secondary L1 Tx/Rx configuration is applicable is received.

In some implementations, the third configuration indicating the secondary L1 Tx/Rx configuration is applicable is received through at least one of an RRC signaling and a DCI.

In some implementations, the target reference signal/target channel may be a UE-dedicated DL/UL channel or signal.

In some implementations, the UE-dedicated DL/UL channel or signal may include at least one of a PDCCH on a UE-specific search space and respective PUSCH/PUSCH, and a dedicated PUCCH resource.

In some implementations, the primary L1 Tx/Rx configuration and the secondary L1 Tx/Rx configuration are associated with a same TRP index or different TRP indexes, respectively.

In some implementations, the at least one L1 Tx/Rx configuration may include multiple L1 Tx/Rx configurations. When the at least one L1 Tx/Rx configuration include multiple L1 Tx/Rx configurations, the second configuration indicates the applicable L1 Tx/Rx configuration(s) among the multiple L1 Tx/Rx configurations.

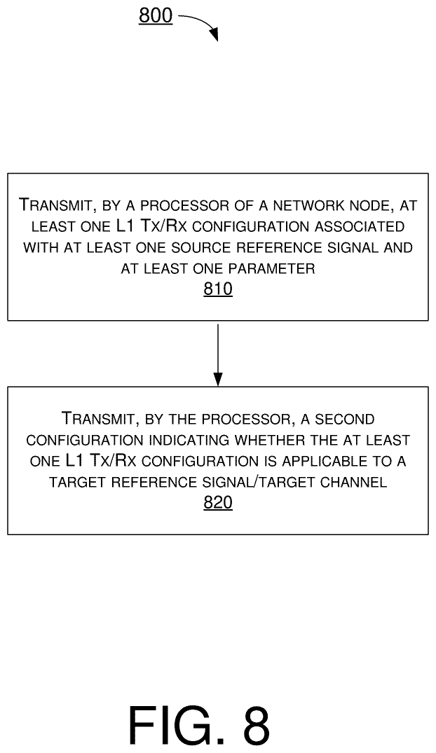

FIG. 8 illustrates another example process 800 in accordance with an implementation of the present disclosure. Process 800 may be an example implementation of above scenarios/schemes, whether partially or completely, with respect to L1 Tx/Rx configuration for QCL in mobile communications. Process 800 may represent an aspect of implementation of features of network apparatus 620 or any suitable network node. Process 800 may include one or more operations, actions, or functions as illustrated by one or more of blocks 810 to 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may begin at block 810.

At block 810, process 800 may involve processor 622 of network apparatus 620 transmitting, via transceiver 626, at least one L1 Tx/Rx configuration associated with at least one source reference signal and at least one parameter. Process 800 may proceed from block 810 to block 820.

At block 820, process 800 may involve processor 622 of network apparatus 620 transmitting, via transceiver 626, a second configuration indicating whether the at least one L1 Tx/Rx configuration is applicable to a target reference signal/target channel.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, at least one layer 1 (L1) transmission or reception configuration associated with at least one source reference signal and at least one parameter;
receiving, by the processor, a second configuration indicating whether the at least one L1 transmission or reception configuration is applicable to a target reference signal or target channel; and
transmitting or receiving, by the processor, the target reference signal or target channel based on the at least one parameter in an event that the second configuration indicates that the at least one L1 transmission or reception configuration is applicable to the target reference signal or target channel.

2. The method of claim 1, wherein the at least one source reference signal comprises a transmission reception point reference signal (TRP-RS), wherein the target reference signal or target channel comprises at least one of a physical downlink shared channel (PDSCH) demodulation reference signal (DM-RS), a physical downlink control channel (PDCCH) DM-RS, a channel state information reference signal (CSI-RS), a physical uplink shared channel (PUSCH), a physical uplink control channel (PUCCH), and a sounding reference signal (SRS).

3. The method of claim 1, wherein the at least one L1 transmission or reception configuration is received through at least one of a radio resource control (RRC) signaling, a medium access control-control element (MAC-CE), and a downlink control information (DCI).

4. The method of claim 1, wherein the at least one parameter comprises at least one of a downlink (DL) related parameter and an uplink (UL) related parameter, and wherein:
the DL related parameter comprises a quasi-colocation (QCL) assumption for DL reception; or
the UL related parameter comprises at least one of a spatial relation for UL transmission, a transmission power control (PC) parameter, and a timing advance (TA) parameter.

5. The method of claim 1, wherein the second configuration indicating whether the at least one L1 transmission or reception configuration is applicable to the target reference signal or target channel is received through at least one of a radio resource control (RRC) signaling and a downlink control information (DCI).

6. The method of claim 1, wherein:
a first target reference signal or target channel associated with a downlink (DL) reception and a second target reference signal or target channel associated with an uplink (UL) transmission are indicated to share at least one L1 transmission or reception configuration; or
the first target reference signal or target channel associated with the DL reception and the second target reference signal or target channel associated with the UL transmission are indicated to follow respective L1 transmission or reception configurations.

7. The method of claim 1, wherein the at least one L1 transmission or reception configuration comprises a primary L1 transmission or reception configuration and a secondary L1 transmission or reception configuration, and the method further comprises:
transmitting or receiving, by the processor, the target reference signal or target channel based on the primary L1 transmission or reception configuration by default; and
transmitting or receiving, by the processor, the target reference signal or target channel based on the secondary L1 transmission or reception configuration in an event that a third configuration indicating the secondary L1 transmission or reception configuration is applicable is received.

8. The method of claim 7, wherein:
the third configuration indicating the secondary L1 transmission or reception configuration is applicable is received through at least one of a radio resource control (RRC) signaling and a downlink control information (DCI); or
the target reference signal or target channel is a user equipment (UE)-dedicated DL or UL channel or signal.

9. The method of claim 8, wherein the UE-dedicated DL or UL channel or signal comprises at least one of a physical downlink control channel (PDCCH) on a UE-specific search space and respective physical uplink shared channel (PUSCH) or physical uplink shared channel (PUSCH), and a dedicated physical uplink control channel (PUCCH) resource.

10. The method of claim 7, wherein the primary L1 transmission or reception configuration and the secondary L1 transmission or reception configuration are associated with a same transmission reception point (TRP) index or different TRP indexes, respectively.

11. The method of claim 1, wherein when the at least one L1 transmission or reception configuration comprises multiple L1 transmission or reception configurations, the second configuration indicates at least one applicable L1 transmission or reception configuration among the multiple L1 transmission or reception configurations.

12. An apparatus, comprising:
a transceiver which, during operation, communicates wirelessly; and
a processor communicatively coupled to the transceiver such that, during operation, the processor performs operations comprising:
receiving, via the transceiver, at least one layer 1 (L1) transmission or reception configuration associated with at least one source reference signal and at least one parameter;
receiving, via the transceiver, a second configuration indicating whether the at least one L1 transmission or reception configuration is applicable to a target reference signal or target channel; and
transmitting or receiving, via the transceiver, the target reference signal or target channel based on the at least one parameter in an event that the second configuration indicates that the at least one L1 transmission or reception configuration is applicable to the target reference signal or target channel.

13. The apparatus of claim 12, wherein the at least one source reference signal comprises a transmission reception point reference signal (TRP-RS), wherein the target reference signal or target channel comprises at least one of a physical downlink shared channel (PDSCH) demodulation reference signal (DM-RS), a physical downlink control channel (PDCCH) DM-RS, a channel state information reference signal (CSI-RS), a physical uplink shared channel (PUSCH), a physical uplink control channel (PUCCH), and a sounding reference signal (SRS).

14. The apparatus of claim 12, wherein:
the at least one L1 transmission or reception configuration is received through at least one of a radio resource control (RRC) signaling, a medium access control-control element (MAC-CE), and a downlink control information (DCI); or
the second configuration indicating whether the at least one L1 transmission or reception configuration is applicable to the target reference signal or target channel is received through at least one of the RRC signaling and the DCI.

15. The apparatus of claim 12, wherein the at least one parameter comprises at least one of a downlink (DL) related parameter and an uplink (UL) related parameter, and wherein:
the DL related parameter comprises a quasi-colocation (QCL) assumption for DL reception; or
the UL related parameter comprises at least one of a spatial relation for uplink (UL) transmission, a transmission power control (PC) parameter, and a timing advance (TA) parameter.

16. The apparatus of claim 12, wherein:
a first target reference signal or target channel associated with a downlink (DL) reception and a second target reference signal or target channel associated with an uplink (UL) transmission are indicated to share at least one L1 transmission or reception configuration; or
the first target reference signal or target channel associated with the DL reception and the second target reference signal or target channel associated with the UL transmission are indicated to follow respective L1 transmission or reception configurations.

17. The apparatus of claim 12, wherein the at least one L1 transmission or reception configuration comprises a primary L1 transmission or reception configuration and a secondary L1 transmission or reception configuration, and during operation, and the processor further performs operations comprising:
transmitting or receiving, via the transceiver, the target reference signal or target channel based on the primary L1 transmission or reception configuration by default; and
transmitting or receiving, via the transceiver, the target reference signal or target channel based on the secondary L1 transmission or reception configuration in an event that a third configuration indicating the secondary L1 transmission or reception configuration is applicable is received.

18. The apparatus of claim 17, wherein:
the third configuration indicating the secondary L1 transmission or reception configuration is applicable is received through at least one of a radio resource control (RRC) signaling and a downlink control information (DCI); or
the target reference signal or target channel is a user equipment (UE)-dedicated DL or UL channel or signal.

19. The apparatus of claim 18, wherein the UE-dedicated DL or UL channel or signal comprises at least one of a physical downlink control channel (PDCCH) on a UE-specific search space and respective physical uplink shared channel (PUSCH) or physical uplink shared channel (PUSCH), and a dedicated physical uplink control channel (PUCCH) resource.

20. The apparatus of claim 17, wherein the primary L1 transmission or reception configuration and the secondary L1 transmission or reception configuration are associated with a same transmission reception point (TRP) index or different TRP indexes, respectively.

21. The apparatus of claim 12, wherein when the at least one L1 transmission or reception configuration comprises multiple L1 transmission or reception configurations, the second configuration indicates at least one applicable L1 transmission or reception configuration among the multiple L1 transmission or reception configurations.

22. A method, comprising:
transmitting, by a processor of a network node, at least one layer 1 (L1) transmission or reception configuration associated with at least one source reference signal and at least one parameter; and
transmitting, by the processor, a second configuration indicating whether the at least one L1 transmission or reception configuration is applicable to a target reference signal or target channel.
